(19) United States
(12) Patent Application Publication
(10) Pub. No.: US 2006/0262399 A1
(43) Pub. Date: Nov. 23, 2006

(54) Optical concentrator

(76) Inventors: Roger Green, Warwichshire (GB); Roberto Ramirez-Iniguez, Coventry (GB)

Correspondence Address: MATHEWS, SHEPHERD, MCKAY, & BRUNEAU, P.A., 29 THANT ROAD, SUITE 201, PRINCETON, NJ, 08540, US

(21) Appl. No.: 10/553,253

(22) PCT Filed: Apr. 7, 2004
(86) PCT No.: PCT/GB04/01522

§ 371 Date: Jun. 30, 2006

(30) Foreign Application Priority Data
Apr. 9, 2003 (GB) 0308128.8

(51) Int. Cl. G02B 27/28

(52) U.S. Cl. 359/487

(57) ABSTRACT

A concentrator having a first surface, a second surface, and a concentrating surface disposed between the first surface and the second surface, the concentrating surface having a first profile which effects concentration of incident radiation at the first surface on to the second surface.

This invention relates to concentrators and wireless communication systems using concentrators.

Research has been carried out in recent years to improve optical wireless communications systems for indoor and outdoor applications. This is because the optical part of the spectrum offers significant advantages when compared to radio as a medium for short range communication. In particular infrared communication provides high bandwidth at low cost, is immune to radio interference and uses a spectrum which is freely available. Furthermore infrared components are inexpensive, small and consume little power. Generally indoor optical wireless communications systems operate in “noisy” environments due to artificial lighting or sunlight. A large number of applications can tolerate only a small path loss, and consequently the transmitter requires a high power output. However the transmitter power output is limited by safety considerations and power consumption. The word “optical” is used in this specification to include infrared and ultraviolet as well as visible light.

It is known that dielectric totally internally reflecting concentrators can be used to collect this infrared light to improve the collection efficiency, and give a wide collection field without having a receiver of excessive length. It is also known in WO 02/21734 to use these concentrators together with a filter in order to discriminate on wavelength and reduce the collection and detection of ambient radiation. However, such receivers do not discriminate against ambient radiation of similar frequency to the transmitted infra red. Such concentrators are also rotationally symmetric and do not allow discrimination based on the plane of incidence.

It is an object of the invention to provide improvements on these designs and in particular to provide a concentrator and/or communication system which can further discriminate against ambient radiation through polarisation and/or plane of incidence and/or provide a transmitter which can polarise radiation and/or transmits differing amounts of radiation in different planes.

According to a first aspect of the invention there is provided a concentrator having a first surface, a second surface, and a concentrating surface disposed between the first surface and the second surface, the concentrating surface having a first profile which effects concentration of incident radiation at the first surface on to the second surface.

Preferably the concentrator is configured to discriminately collect incident radiation depending on polarisation such that incident radiation which reaches the second surface has a higher proportion of radiation that is plane polarised in a predetermined orientation than the radiation incident at the first surface.

Preferably the concentrator comprises a polarising filter preferably along an optical path which passes through the first and second surfaces. More preferably the polarising filter is adjacent/proximal the second surface and/or is adjacent the first surface and/or the first surface comprises a polarising filter.

Preferably the first profile is designed such that only incident radiation having an angle of incidence within a predetermined acceptance angle is concentrated by the first profile to the second surface.

Preferably the concentrator comprises a second profile disposed between the first and second surfaces which second profile is shaped to concentrate less incident radiation than the first profile. More preferably the predetermined acceptance angle of the second profile is smaller than acceptance angle of the first profile.

Preferably the first surface has a major diameter/dimension and a minor diameter/dimension wherein the major diameter/dimension is longer than the minor diameter/dimension. More preferably the major and minor diameter/dimensions are substantially perpendicular and/or the major diameter/dimension is delimited by the first profile and/or the minor diameter/dimension is delimited by the second profile.

Preferably the first surface is oval or elliptical and/or is convex in at least one plane and preferably in the plane of the first profile.

Preferably the concentrating surface has a concavely curved portion and the first profile is in the concavely curved portion, and/or has a substantially straight or flat portion and more preferably the second profile is in the substantially straight or flat portion.

Preferably the first profile is designed to optimally totally internally reflect.

Preferably the first surface and/or the concentrator is rotationally asymmetric and/or is symmetrical about a central plane.

Preferably the polarising filter filters radiation polarised in the direction of the minor axis and/or perpendicular to a plane containing the first profile.

Preferably the cross section of the concentrator along the concentrating surface is rotationally asymmetric and more preferably is oval or substantially rectangular.

Preferably the concentrator comprises a narrow band pass filter.

Preferably the concentrator has a body comprising an optically transmissive material, which body is delimited by the first, second and concentrating surfaces. More preferably the body is dyed to act as an optical filter.

Preferably the second surface has an anti reflective coating.

Preferably there is provided a communication receiver comprising a concentrator according to the invention and a photodetector adjacent the second surface for detecting incident radiation which reaches the second surface and providing an output signal indicative of the radiation detected.

Preferably there is provided a communication transmitter comprising a concentrator according to the invention and an emitter adjacent the second surface for emitting radiation from the second surface, the first profile effecting diffusion of emitted radiation from the second surface on to the first surface, and radiation being transmitted from the first surface. More preferably the transmitter is configured to discriminately transmit emitted radiation depending on polarisation such that emitted radiation which leaves the first surface has a higher proportion of radiation that is plane polarised in a predetermined orientation than the radiation emitted by the emitter. Preferably still the transmitter comprises a second profile disposed between the first and second surfaces which second profile is shaped to diffuse less emitted radiation than the first profile.

Preferably there is provided a communication system comprising a concentrator or receiver according to the invention and a radiation emitter wherein the concentrator/receiver receives radiation emitted from the emitter. More preferably the radiation emitted by the emitter is polarised and preferably still is emitted by the emitter is polarised in the direction normal to the orientation filtered by the polarising filter and/or in the direction of the major diameter/dimension or plane containing the first profile and/or the radiation emitted is substantially coplanar with the major diameter/dimension or plane containing the first profile of the concentrator.

Preferably the communication system comprises a second communication receiver orientated so that the polarising filter of the second receiver filters out the emitted radiation and wherein the signal from the second concentrator is subtracted from the signal from the first concentrator to remove ambient radiation from the combined signal.

Preferably the radiation emitter comprises/forms part of a radiation transmitter according to the invention

Preferably the emitted radiation is in the infrared spectrum.

According to a second aspect of the invention there is provided an optical transceiver/device for a wireless communication system comprising an optically transmissive body having a first and second end and a reflecting surface disposed between the first and second end, which reflecting surface (totally internally) reflects radiation passing through the body onto the first or second end wherein an optical polarising filter is located between the first and second ends such that it polarises radiation that passes through the body. Preferably the first end has a larger surface area than the second end and the reflecting surface is shaped such that radiation passing through the body from the second end to the first end is concentrated and radiation passing through the body from the first end to the second end is diffused and/or the first end has a major diameter/dimension and a minor diameter/dimension wherein the major diameter/dimension is longer than the minor diameter/dimension and the angle of field is greater along the major diameter/dimension than along the minor diameter/dimension.

Embodiments of the invention will now be described, by way of example only, with reference to the accompanying drawings in which;

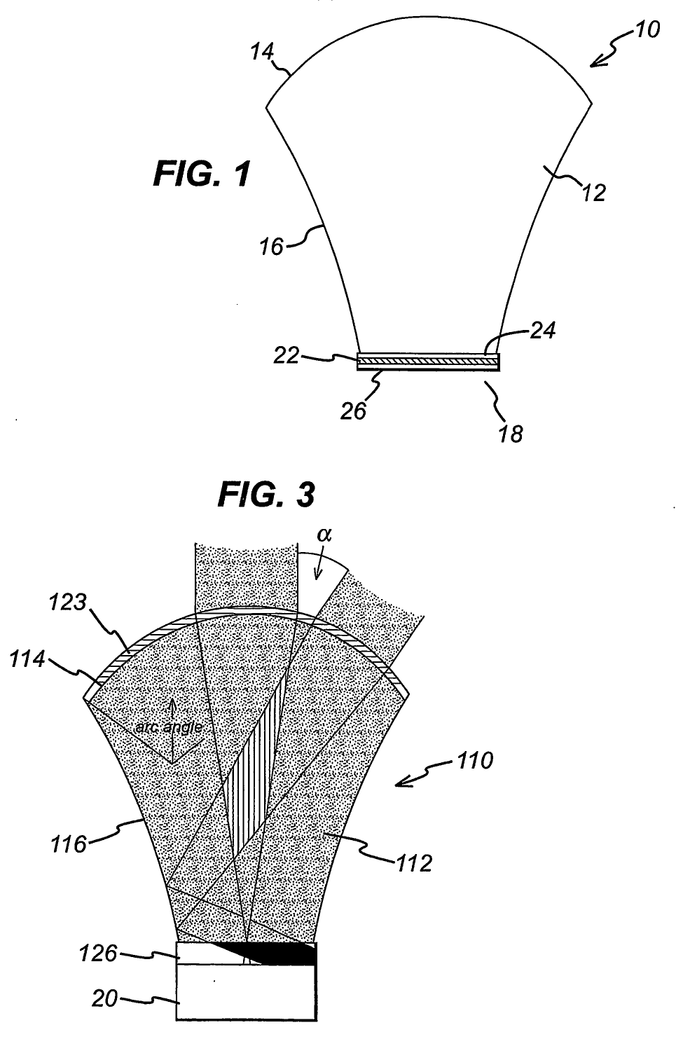

FIG. 1 is a top down cross sectional view of a concentrator according to the invention,

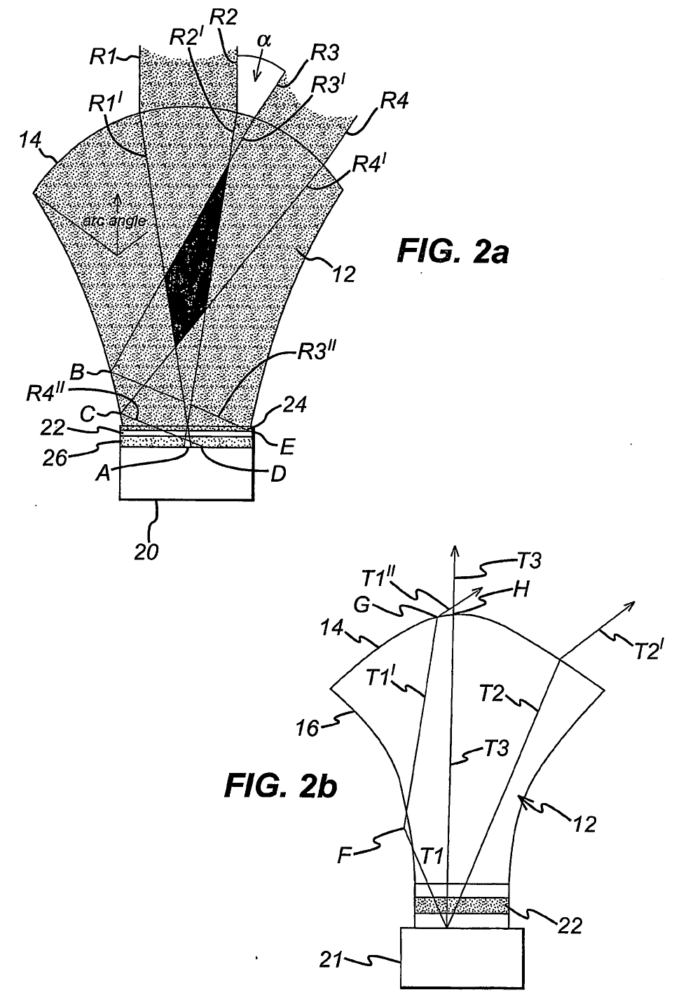

FIG. 2a is a top down cross sectional view of a receiver comprising the concentrator of FIG. 1 with rays of radiation depicted for illustrative purposes,

FIG. 2b is a top down cross sectional view of a receiver comprising the concentrator of FIG. 1 with emitted rays depicted for illustrative purposes,

FIG. 3 is a top down cross sectional view of a second embodiment of receiver according to the invention with rays of radiation depicted for illustrative purposes,

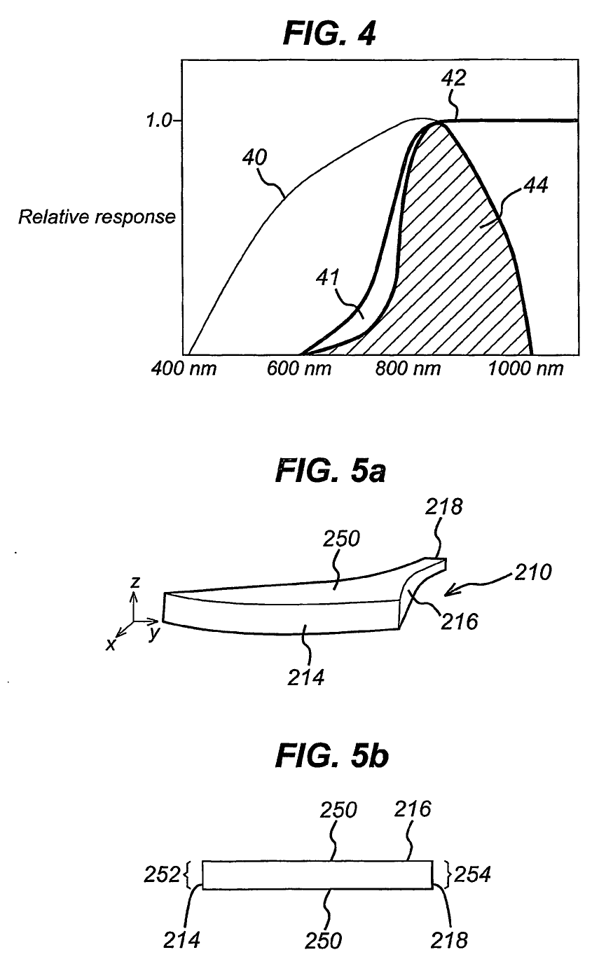

FIG. 4 is a graph showing the transmission curve of a dyed dielectric material superimposed on the typical responsivity of a silicon based photodetector,

FIG. 5a is a front perspective view of a third embodiment of concentrator according to the invention,

FIG. 5b is a side view of the concentrator of FIG. 5a,

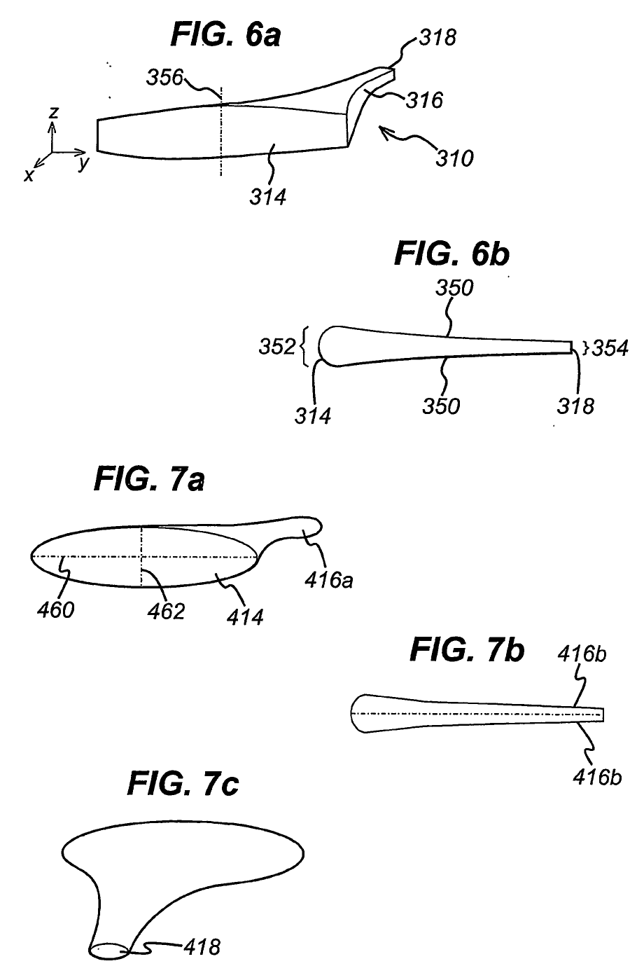

FIGS. 6a and 6b are respectively front perspective and side views of a fourth embodiment of concentrator according to the invention,

FIGS. 7a and 7b are respectively front perspective and side views of a fifth embodiment of concentrator according to the invention,

FIG. 7c is a rear perspective view of the concentrator of FIGS. 7a and 7c,

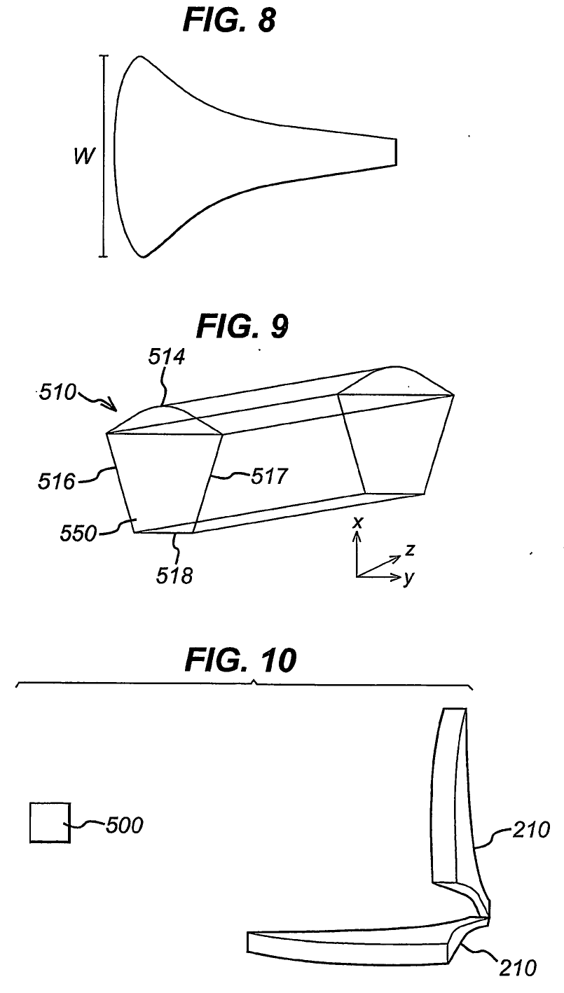

FIG. 8 is a top view of the concentrators of FIGS. 5, 6 and 7,

FIG. 9 is a perspective view of a sixth embodiment of concentrator according to the invention, and

FIG. 10 is a schematic view of a communication system according to the invention comprising two concentrators of FIG. 5.

FIG. 1 shows a concentrator 10, preferably a dielectric totally internally reflecting concentrator (DITRC) made predominantly of a dielectric material 12 that is transmissive to infrared light. The dielectric 12 has a high refractive index, and could for example be perspex or crown glass. In the embodiments described in detail infrared radiation is used since it provides high bandwidth at low cost, however, alternative embodiments can use visible light, ultra violet or other electromagnetic radiation.

The concentrator 10 has a convexly curved first surface 14, a concavely curved side surface 16 and a substantially flat second surface 18. In this embodiment, the concentrator 10 has a conventional shape with the side surface 16 being rotationally symmetric such that the cross section of the concentrator 10 and the second surface 18 are circular normal to the plane of the page of FIG. 1.

Located between the second surface 18 and first surface 14 is a polarising filter 22 sandwiched between index matching films 24 and 26 for matching the refractive index of the polarising filter to the refractive indices on either side of the filter. One of the matching layers 26 is adjacent to the detecting surface 18.

The concentrator 10 can be used to receive radiation from a specific infrared source which emits infrared radiation that is plane polarised. The polarising filter is selected to filter out light polarised perpendicularly to the infrared source to reduce the amount of ambient radiation detected without limiting detection of radiation from the specific infrared source.

A photodetector 20 as shown in FIG. 2a, such as an infrared detector, can be located adjacent the second surface 18 so that it functions as a second surface 18. Together the concentrator 10 and photodetector 20 form a communication receiver capable of receiving and detecting infra red radiation from a source which may be representative of information.

In FIG. 2a is shown how incident rays are refracted through the concentrator 10 to the photodetector 20. Two direct parallel rays R1 and R2 pass through the first surface 14 and are refracted towards each other as rays R1′ and R2′. Rays R1′ and R2′ actually cross each other around the polarising filter 22 and reach the second surface 18 at substantially the same point A. This radiation that reaches A is then detected by the photodetector 20 and a representative signal is produced. If rays R1 and R2 had been completely plane polarised in a orientation perpendicular to that which is wished to be received then the radiation would be cut out be the filter 22 and would not reach A.

Two parallel rays R3 and R4 are incident on the first surface 14 at an acceptance angle α. As the rays R3 and R4 pass through the first surface 12 they are refracted towards each other as rays R3′ and R4′. Rays R3′ and R4′ reach the totally internally reflecting side surface 16 at points B and C respectively and are then reflected as rays R3″ and R4″ and reach points D and E on the second surface 18. Point E is on the very edge of second surface 18. Consequently any rays that enter at an angle greater than the acceptance angel α will miss the second surface 18 and exiting via the side surface 16 and so will not be detected.

Alternatively a radiation emitter 21, in this case an infrared light emitting diode, can be located adjacent the second surface 18. Together the concentrator 10 and emitter 21 form a communication transmitter capable of transmitting infra red radiation which may be representative of information. The transmitted radiation will have been plane polarised by polarising filter 22 and accordingly such a communication transmitter can be used as the specific radiation source for a communication receiver according to the invention.

In FIG. 2b is shown how transmitted rays are refracted through the concentrator 10 from an emitter 21 when the concentrator 120 is being used as a communication transmitter. Used in this way concentrator 10 does not concentrate light but diffuses light in a controlled manner.

A first transmitted ray T1 travels from the emitter 21 past the second surface 18 and reaches the totally internally reflecting side surface 16 at point F and is then reflected as rays T1′ and reaches point G on the first surface 14. At the first surface ray T1′ is refracted as ray T1″ and continues beyond the concentrator 10.

Transmitter ray T2 is emitted at such an angle that it does not hit the side surface 16 but passes directly to the first surface 14 here it is refracted as ray T2′.

Ray T3 passes directly to the first surface 14 at point H. The ray T3 is normal to the surface 14 at point H so is not refracted but instead continues to be transmitted beyond the concentrator 10 at the same angle at which it left the emitter 21.

The 3D profile of the concentrator 10 is designed by finding the optimal profile for the 2D case and rotating the 2D profile about its axis of symmetry.

The first surface 14 is a portion of a sphere or conoid such as a paraboloid or hyperboloid, and the slope of the side surface 16 is determined in accordance with the requirements of total internal reflection. It is also possible to take account in the design of other subsidiary conditions, such as the requirement for the angle of incidence of light on the second surface not to exceed a certain value if a flat interference filter is used.

The concentrator 10 can be designed in such a way that the reflected rays do not exceed a maximum value of incidence. In which case the design is based on the phase conserving method by which the exiting extreme rays form a new wavefront after reflection by the side surface 16, and the reflected rays must exist within a predetermined maximum angle α.

Alternatively the design need not have a predetermined maximum angle α and can be based on the maximum concentration method free of this constraint.

The profile coordinates can be calculated analytically as described in published patent application WO 02/217234 optimizing the collection of radiation incident at an angle less than α or collection of radiation can be optimized independent of angle α using the maximum concentration method as described for example in Applied Optics Vol 26 No. 2 15 Jan. 1987, “Dielectric totally internal reflecting concentrators” by Xiachui Ning, Roland Winston and Joseph O'Gallagher.

In some embodiments the index of refraction of dielectric 12 is chosen to be as high as possible, in order to achieve maximum concentration with small size. Furthermore, a high index of refraction gives rise to a high geometrical concentration.

In FIG. 3 is shown a second embodiment of concentrator 110. Parts of the concentrator 110 which are substantially similar to parts of concentrator 10 are labeled with a reference number one hundred greater than the corresponding parts of concentrator 10.

Instead of a flat polarising filter 22, concentrator 110 has a polarising filter 123 on the first surface 14. The concentrator 110 has only one matching layer 126 which matches the refractive indices of the dielectric material 112 and the photodetector 20. It should also be noted that a polarising filter can be placed in front of and remote from a concentrator. Accordingly, a flat polarising filter can be provided which is not in contact with the first surface of the concentrator.

Either concentrator 10 or 110 may also include in addition a narrow band optical filter (such as proximal to the photodetector 20 or on the first surface 14). In this case the profile will preferably have been designed using the phase conservation method and the acceptance angel α will be chosen to be suitable for use with the filter, since such filters often have a strong dependence on the angle of incidence. Use of such an optical filter can further discriminate against ambient radiation by cutting out radiation with wave length significantly different to the wavelength of radiation from the desired source.

Such wavelength discrimination can also be implemented by using a coloured optical material for the dielectric 12 or 112. The dielectric material 12 or 112 can be dyed to reduce visible light transmission, and additionally the photodetector 20 can comprise silicon, which has the desirable property that it is not sensitive to the longer wavelength infrared radiation. The overall response of such a configuration is shown in FIG. 4, where the response characteristic 40 of the silicon photodetector 20 is shown superimposed on the response 42 of the dyed dielectric 12. In effect the dyed dielectric material 12 or 112 acts as an infrared long pass filter.

It can be seen that the photodetector responds only to wavelengths below 1000 nm, whereas the long pass filter passes wavelengths over about 600 nm giving a maximum optical bandwidth of about 400 nm as indicated by the shaded region 42 in FIG. 4. Area 41 represents the non-precise overlap between responses of the photodetector and filter.

The dielectric 12 or 112 can be fabricated in coloured plastics or glass, or a GaAs substrate. The transmission characteristics of such coloured dielectrics are substantially independent of the angle of incidence of the light so that when designing the profile of the concentrator the angle of incidence of the light need not be a consideration and the maximum concentration method may be used.

In FIGS. 5a, and 5b and 8 is shown a third embodiment of concentrator 210. The top down view of concentrator 210 is substantially similar to the cross sections of concentrator 10 shown in FIG. 1. The first surface 214 is convex and the side surface 216 is concavely curved and its profile designed as with side surface 16 to maximise collection of radiation within a predetermined angle range. Consequently light incident in the horizontal plane x,y is collected in much the same way as light incident on concentrator 10.

Instead of being rotationally symmetric the cross section of concentrator 310 is substantially constant through the vertical direction z. The concentrator 210 comprise top and bottom surfaces 250 which are substantially flat and the first surface 214 is also substantially flat in the vertical z direction best shown in FIG. 5b. Light incident in the vertical x,z plane is therefore received by the substantially rectangular profile shown in FIG. 5b. Such a rectangle does not concentrate in the vertical x,z plane. Firstly the receiving end 252 from which radiation is received is not significantly larger than the detecting end 254 and therefore radiation is only collected over a narrow field of view. Secondly, the profiles of the top and bottom surfaces will only internally reflect radiation from a very narrow range of angles and the radiation must be reflected several times before it reaches second surface 218.

Because of its profile, concentrator 310 will collect and detect far more light incident in the horizontal x, y plane than from the vertical x,z plane. This is advantageous when used in situation where incident infrared radiation from a desired source, and any corresponding optical alignments, are in the horizontal plane. The concentrator can also be used to discriminate in favour of the vertical plane x,z simply be being rotated 90 degrees.

This asymmetrical design and radiation capture is complementary with the use of polarising filters 22 or 123 of the type described for concentrators 10 and 110. Ambient radiation will frequently be polarised or part polarised in a direction normal to its plane of incidence due to the effect of reflections from dielectric surfaces. Therefore since most of the ambient radiation collected by the asymmetric concentrator 210 is from the horizontal plane much of it will be vertically polarised. By using a polarising filter which filters out vertically polarised radiation a great proportion of ambient radiation can be prevented from reaching the second surface 218. Information that is desired to be detected can be transmitted in the horizontal plane but polarised horizontally so that this information will not be affected by the polarising filter and will be collected over a wide range of field.

In FIGS. 6a and 6b is shown a fourth embodiment of concentrator 310 according to the invention which is also asymmetric. The top down profile is substantially identical to concentrator 210 and is also represented by FIG. 8. Side surfaces 316 are substantially identical to side surface 216, however, the first surface 314 is taller at its centre 356 than at side surfaces 316 and the cross section across the centre in the x,z plane as shown in FIG. 6b shows significant differences to concentrator 210. The first surface 314 is convex in the vertical z direction and the receiving end is significantly taller than the receiving end 354 (though still much smaller than horizontal width W in FIG. 8). This leads to a wider range of field in the vertical z direction though again still much less than in the horizontal y direction.

The top and bottom surfaces 350 in the centre 356 are concavely curved and therefore will internally reflect radiation from a grater range of angles than surfaces 250 but are not optimised using the process described in WO 02/21734 so will not reflect as much radiation onto the second surface 318 as side surfaces 316.

Concentrator 310 has a wider range of field than concentrator 210 but still collects more radiation from the horizontal x,y plane than the vertical y,z plane. This embodiment can be used in the same way as concentrator 210 and is similarly suitable for use with a polarising filter. Concentrator 310 is particularly beneficial in circumstances in which the plane of incidence of information originating from the desired source can not be guaranteed to be exactly horizontal. Concentrator 310 also requires less precise optical alignment.

A fifth embodiment of concentrator 410 is shown in FIGS. 7a, 7b and 7c. Concentrator 410 has an oval cross section in the z,y plane and has an oval shaped first surface 414. The maximum diameter 460 of the oval occurs in the horizontal direction and the minimum diameter 462 occurs in the vertical direction. The top down view of the concentrator is again represented by FIG. 8 and the profile of the side surface 416a at the maximum diameter 460 is substantially the same as side surfaces 216 and 316.

The x,z vertical cross section of the concentrator 410 through the minimum diameter 462 shown in FIG. 7b and is substantially similar to the corresponding cross section of concentrator 410 shown in FIG. 6b. The design of the profile of the side surface 416b is least optimised for the minimum diameter 462 and the vertical plane is the plane from which least radiation is reflected onto the second surface 418. The side surface 416 graduates between the vertical and horizontal planes along with the diameter so that the amount of radiation reflected to reach the second surface 418 increases steadily between these extreme cases.

In FIG. 9 is shown a sixth embodiment of concentrator 510 according to the invention which is also asymmetric. Concentrator 510 is similar to concentrator 210. The first surface 514 is convex but the side surfaces 516 and 517 are substantially straight but inclined relative to each other such that the concentrator 510 narrows between first surface 514 and second surface 516

The cross section of concentrator 510 is substantially constant through the direction z. The top and bottom surfaces 550 are substantially flat as with concentrator 210 but are separated by a greater relative distance with second surface 518 and first surface 514 being much longer in the z direction than they are wide in the y direction. Therefore whist concentrator 510 has a greater angle of field in the z, y plane than concentrator 210 any light collected from this plane onto the second surface 516 has a low intensity since it is spread over a wide area.

The embodiments 110, 210, 310, 410 and 510 can be used to collect light and may be used together with a photodetector and a communication receiver as shown for concentrator 10 in FIG. 2a. Alternatively all of these embodiment and also be used together with an emitter 21 as a communication transmitter as shown in FIG. 2b. Where the above description mentions more or less light being concentrated in different planes this similarly applies for diffusion when light is emitted. The asymmetric concentrators 210, 310, 410 and 510 can be used to control diffusion so that for example more light is transmitted in the horizontal plane than in the vertical plane or that light in the vertical plane is spread over a wider area than in the horizontal plane.

A communication receiver and a communication transmitter both comprising a concentrator 10, 110, 210, 301, 410 or 510 can be used together to form a communication system. In this set up the receive will be orientated such that none of the polarised light emitted by the transmitter is blocked by the polarising filter 22 of the receiver.

When such a system is used with asymmetric concentrators such as concentrator 310, the transmitter can be orientated such that more light is transmitted and over a wider angle in a particular plane whilst the receiver can be orientated so that it discriminates in favour of light transmitted in that particular plane.

This combination of a polarising transmitter and polarised receiver optic ensures a very high degree of ambient illumination rejection for the following reasons: firstly the emitted- and detected radiation carrying the information are coplanar. Secondly, there is a reasonably equal distribution of ambient illumination (man made, such as indoor- or outdoor lighting) in both perpendicular planes.

In FIG. 10 is shown two concentrators 210, one aligned horizontally and one vertically both comprising polarising concentrators fitted which filter radiation polarised in the direction normal to the orientation of the concentrator 210.

The transmitting source 500 of the signal to be transferred optically through the concentrators 210 can carry certain information in horizontal polarisation and certain information in vertical polarisation, and in this case signals from the two concentrators 210 can be correlated. This provides significant increases in the common mode rejection of ambient illumination signals.

The transmitting source can also carry an information signal δ in horizontal or vertical polarisation only and preferably via a concentrator 210 so that most of the signal δ is in one plane.

With the two polarising concentrators 210 used for reception, one of the receivers will receive the transmitted information signal δ along with some ambient radiation and one will only receive ambient radiation A with the transmitted information signal δ being cut out by the polarising filter 222.

Any modulation of the ambient illumination (mains frequency-related intensity modulation) is approximately equal in either plane. This means that subtraction of one of the received signals from the other will yield the information signal, i.e.: ([A+δ]−A)=δ, where δ is the information signal, and A is the ambient signal contribution from each of the two channels.

1. A concentrator having a first surface, a second surface, and a concentrating surface disposed between the first surface and the second surface, the concentrating surface having a first profile which effects concentration of incident radiation at the first surface on to the second surface, and which is configured to discriminately collect incident radiation depending on polarisation such that incident radiation which reaches the second surface has a higher proportion of radiation that is plane polarised in a predetermined orientation than the radiation incident at the first surface.

2. A concentrator according to claim 1 which comprises a polarising filter preferably along an optical path which passes through the first and second surfaces.

3. A concentrator according to claim 2 wherein the polarising filter is adjacent and/or proximal the second surface.

4. A concentrator according to claim 3 wherein a polarising filter is adjacent the first surface and/or the first surface comprises a polarising filter.

5. A concentrator having a first surface, a second surface, and a concentrating surface disposed between the first surface and the second surface, the concentrating surface having a first profile which effects concentration of incident radiation at the first surface on to the second surface.

6. A concentrator according to claim 1 wherein the first profile is designed such that only incident radiation having an angle of incidence within a predetermined acceptance angle is concentrated by the first profile to the second surface.

7. A concentrator according to claim 1 comprising a second profile disposed between the first and second surfaces which second profile is shaped to concentrate less incident radiation than the first profile.

8. A concentrator according to claim 6 wherein the predetermined acceptance angle of the second profile is smaller than acceptance angle of the first profile.

9. A concentrator according to claim 1 wherein the first surface has a major diameter/dimension and a minor diameter/dimension wherein the major diameter/dimension is longer than the minor diameter/dimension.

10. A concentrator according to claim 9 wherein the major and minor diameter/dimensions are substantially perpendicular.

11. A concentrator according to claim 9 wherein the major diameter/dimension is delimited by the first profile.

12. A concentrator according to claim 9, wherein the minor diameter/dimension is delimited by the second profile.

13. A concentrator according to claim 1 wherein the first surface is oval or elliptical.

14. A concentrator according to claim 1 wherein the first surface is convex in at least one plane and preferably in the plane of the first profile.

15. A concentrator according to claim 1 wherein the concentrating surface has a concavely curved portion and the first profile is in the concavely curved portion.

16. A concentrator according to claim 7 wherein the concentrating surface has a substantially straight or flat portion and preferably the second profile is in the substantially straight or flat portion.

17. A concentrator according to claim 1 wherein the first profile is designed to optimally totally internally reflect.

18. A concentrator according to claim 1 wherein the first surface and/or the concentrator is rotationally asymmetric.

19. A concentrator according to claim 1 wherein the first surface and/or the concentrator is symmetrical about a central plane.

20. A concentrator according to claim 2 wherein the polarising filter filters radiation polarised in the direction of the minor axis and/or perpendicular to a plane containing the first profile.

21. A concentrator according to claim 1 wherein the cross section of the concentrator along the concentrating surface is rotationally asymmetric.

22. A concentrator according to claim 1 wherein the cross section of the concentrator along the concentrating surface is oval or substantially rectangular.

23. A concentrator according to claim 1 comprising a narrow band pass filter.

24. A concentrator according to claim 1 having a body comprising an optically transmissive material, which body is delimited by the first, second and concentrating surfaces.

25. A concentrator according to claim 24 wherein the material of the body is dyed to act as an optical filter.

26. A concentrator according to claim 1 comprising an anti reflective coating on the second surface.

27. A communication receiver comprising a concentrator according to claim 1 and a photodetector adjacent the second surface for detecting incident radiation which reaches the second surface and providing an output signal indicative of the radiation detected.

28. A communication transmitter comprising a concentrator according to claim 1 and an emitter adjacent the second surface for emitting radiation from the second surface, the first profile effecting diffusion of emitted radiation from the second surface on to the first surface, and radiation being transmitted from the first surface.

29. A transmitter according to claim 28 which is configured to discriminately transmit emitted radiation depending on polarisation such that emitted radiation which leaves the first surface has a higher proportion of radiation that is plane polarised in a predetermined orientation than the radiation emitted by the emitter.

30. A transmitter according to claim 28 comprising a second profile disposed between the first and second surfaces which second profile is shaped to diffuse less emitted radiation than the first profile.

31. A communication system comprising a concentrator or receiver according to claim 1 and a radiation emitter wherein the concentrator/receiver receives radiation emitted from the emitter.

32. A communication system according to claim 31 wherein the radiation emitted by the emitter is polarised.

33. A communication system according to claim 32 wherein the radiation emitted by the emitter is polarised in the direction normal to the orientation filtered by the polarising filter and/or in the direction of the major diameter/dimension or plane containing the first profile.

34. A communication system according to claim 32 wherein the radiation emitted by the emitter is substantially coplanar with the major diameter/dimension or plane containing the first profile of the concentrator.

35. A communication system according to claim 33 comprising a second communication receiver orientated so that the polarising filter of the second receiver filters out the emitted radiation and wherein the signal from the second concentrator is subtracted from the signal from the first concentrator to remove ambient radiation from the combined signal.

36. A communication system according to claim 31 wherein the radiation emitter comprises/forms part of a radiation transmitter.

37. A communication system according to claim 31 wherein the emitted radiation is in the infrared spectrum.

38. An optical transceiver/device for a wireless communication system comprising an optically transmissive body having a first and second end and a reflecting surface disposed between the first and second end, which reflecting surface (totally internally) reflects radiation passing through the body onto the first or second end wherein an optical polarising filter is located between the first and second ends such that it polarises radiation that passes through the body.

39. An optical transceiver/device according to claim 38 in which the first end has a larger surface area than the second end and the reflecting surface is shaped such that radiation passing through the body from the second end to the first end is concentrated and radiation passing through the body from the first end to the second end is diffused.

40. A transceiver/device according to claim 38 in which the first end has a major diameter/dimension and a minor diameter/dimension wherein the major diameter/dimension is longer than the minor diameter/dimension and the angle of field is greater along the major diameter/dimension than along the minor diameter/dimension.
